(19) United States
(12) Patent Application Publication
(10) Pub. No.: US 2014/0347862 A1
(43) Pub. Date: Nov. 27, 2014

(54) LED Sphere Lighting Device

(71) Applicant: Chi-Pao Tang, Nantou County (TW)

(72) Inventor: Chi-Pao Tang, Nantou County (TW)

(21) Appl. No.: 13/902,890

(22) Filed: May 27, 2013

(51) Int. Cl. F21V 3/02

(52) U.S. Cl. CPC F21V 3/02
USPC 362/294

(57) ABSTRACT

The invention provides a light emitting diode (LED) sphere lighting device. The LED sphere lighting device comprises a power connector. The power connector is configured with a heat sink, and the heat sink is configured with a lamp cover. An LED lighting device is disposed in the lamp cover and electrically connects to the power connector. The improvement comprises: the lamp cover is a sphere shell; a largest diameter of the lamp cover is larger than a diameter of the top surface of the heat sink; and the lamp cover has a curved surface extending outward, bending, and enlarging from the top surface of the heat sink to increase an illumination angle.

### BACKGROUND OF THE INVENTION

1. Field of the Invention

The present invention provides a light emitting diode (LED) sphere lighting device. More particularly, the invention relates to technically increasing an illumination angle with a curved surface of a lamp cover.

2. Descriptions of the Related Art

With the advancement of lighting technology and global popularization of the concept of energy efficiency, LEDs are widely used in all kinds of illumination devices. The advantages of LEDs are smaller size, higher efficiency, lower energy consumption, and so on. However, the smaller illumination angle is a problem of the conventional LED lighting device, as shown in FIG. 3. Because the lamp cover 80 is designed as a hemisphere, the heat sink 90 shades and the light under or on the side of the lamp cover 80 is very weak.

As a result, developing a more ideal and practical innovation structure to solve the problem of the abovementioned structure is highly expected by the consumers and becomes the breakthrough goal for the related industry to research.

In view of this situation, the inventor designs in detail and deliberately evaluates to approach the recited goals, and provides the practical present invention based on the years' manufacturing, developing and design experience in the related products.

### SUMMARY OF THE INVENTION

The technical problem of the conventional LED lighting lamp is the smaller illumination angle. Moreover, since the lamp cover is designed as a hemisphere, the heat sink shades and the light under or on the side of the lamp cover is very weak.

The technical approach to solve the problem is to provide a light emitting diode (LED) sphere lighting device, comprising a power connector, configured with a heat sink, the heat sink being configured with a lamp cover, an LED lighting device being disposed in the lamp cover and on a top surface of the heat sink, the LED lighting device electrically connecting to the power connector, wherein the improvement comprises: the lamp cover being a sphere shell, a largest diameter of the lamp cover being larger than a diameter of the top surface of the heat sink, and the lamp cover having a curved surface extending outward, bending, and enlarging from the top surface of the heat sink to increase an illumination angle.

An outer surface of the power connector is formed with external threads.

At least one through hole penetrates lateral periphery of the heat sink to improve convection and heat dissipation.

Comparing with the prior art, the heat sink and the through hole of the present invention improve convection and heat dissipation, and the lifetime of the lighting device is extended. The lamp cover has a curved surface extending outward, bending, and enlarging from the top surface of the heat sink to increase a transparency area of the lamp cover. The LED lighting device is less shaded by the heat sink, and the illumination angle is increased to evenly light up the area under and around the lamp cover.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an exploded drawing in accordance with an embodiment of the present invention;

FIG. 2 illustrates a schematic drawing of the lighting device in use in accordance with an embodiment of the present invention; and

FIG. 3 is a schematic diagram illustrating the conventional lighting device in use.

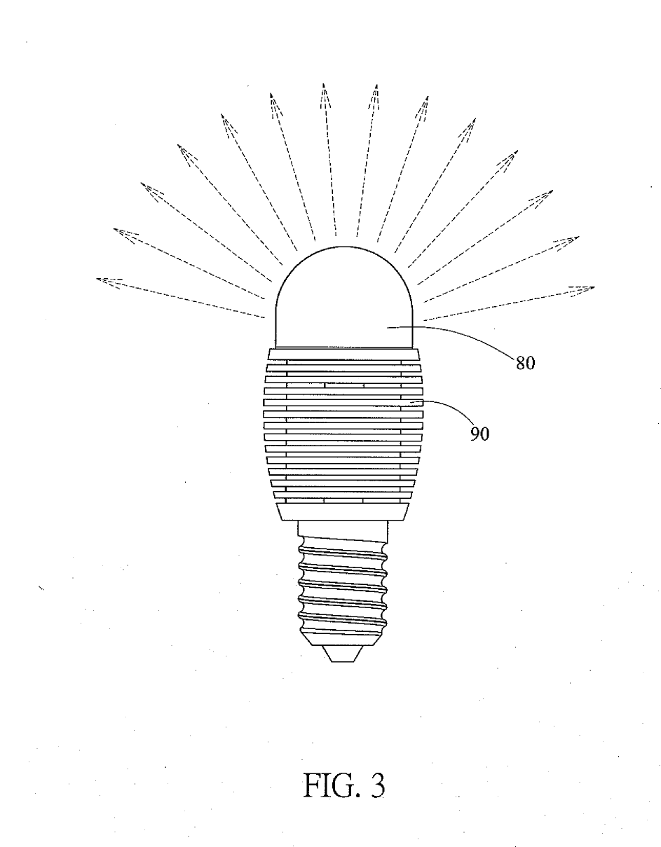

### DESCRIPTION OF THE PREFERRED EMBODIMENT

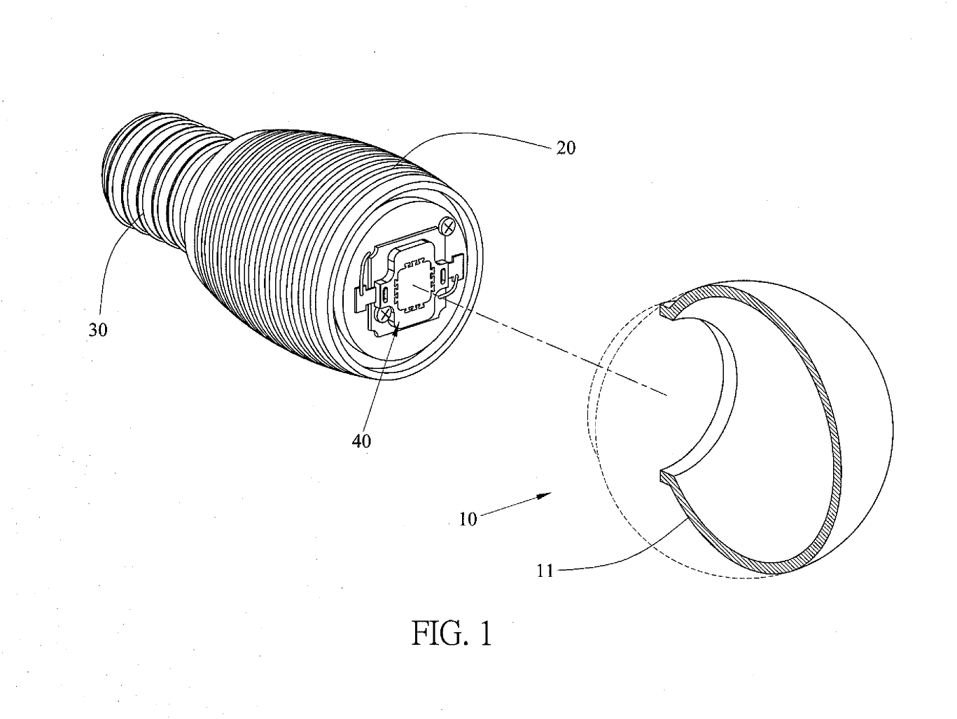

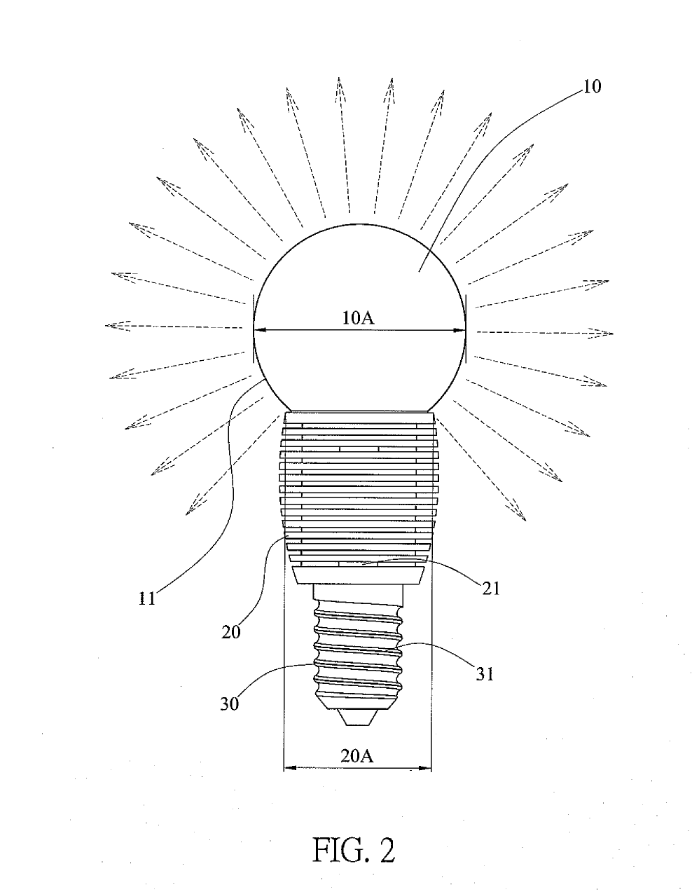

The invention provides a light emitting diode (LED) sphere lighting device as shown in FIGS. 1 and 2. The LED sphere lighting device comprises a power connector 30, which is configured with a heat sink 20. The heat sink 20 is configured with a lamp cover 10. The lamp cover 10 can be a transparent lamp cover, a translucent lamp cover or a fog lamp cover. An LED lighting device 40 is disposed in the lamp cover 10 and on a top surface of the heat sink 20. At least one through hole 21 penetrates lateral periphery of the heat sink 20 to improve convection and heat dissipation. The LED lighting device 40 electrically connects to the power connector 30. An outer surface of the power connector 30 is formed with external threads 31. The features of the present inventions are as follows. The lamp cover 10 is a sphere shell, and a largest diameter 10A of the lamp cover 10 is larger than a diameter 20A of the top surface of the heat sink 20. The lamp cover 10 has a curved surface 11 extending outward, bending, and enlarging from the top surface of the heat sink 20 to increase a transparency area of the lamp cover 10. The LED lighting device 40 is less shaded by the heat sink 20, and the illumination angle is increased.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light emitting diode (LED) sphere lighting device, comprising a power connector, configured with a heat sink, the heat sink being configured with a lamp cover, an LED lighting device being disposed in the lamp cover and on a top surface of the heat sink, the LED lighting device electrically connecting to the power connector, wherein the improvement comprises:
the lamp cover being a sphere shell, a largest diameter of the lamp cover being larger than a diameter of the top surface of the heat sink, and the lamp cover having a curved surface extending outward, bending, and enlarging from the top surface of the heat sink to increase an illumination angle.

2. The LED sphere lighting device as claimed in claim 1, wherein external threads are formed on an outer surface of the power connector.

3. The LED sphere lighting device as claimed in claim 1, wherein at least one through hole penetrates lateral periphery of the heat sink to improve convection and heat dissipation.
